(19) United States
(12) Patent Application Publication
(10) Pub. No.: US 2024/0425127 A1
(43) Pub. Date: Dec. 26, 2024

(54) CRAWLER CHAIN

(71) Applicant: DST DEFENCE SERVICE TRACKS GMBH, Remscheid (DE)

(72) Inventors: Markus PARIZEK, Mettmann (DE); Jürgen KENSY, Marl (DE)

(21) Appl. No.: 18/692,897

(22) PCT Filed: Sep. 21, 2022
(86) PCT No.: PCT/DE2022/100707

§ 371 Date: Mar. 18, 2024

(30) Foreign Application Priority Data
Sep. 22, 2021 (DE) 10 2021 124 576.1

(51) Int. Cl. B62D 55/21; B62D 55/26

(52) U.S. Cl. CPC B62D 55/21; B62D 55/26

(57) ABSTRACT

A track chain for tracked vehicles, in particular for military tracked vehicles, having a plurality of chain links which are arranged one behind the other in the chain direction and are pivotably connected to one another, each having two connecting means. At least one connecting means is designed as a tubular bolt receptacle extending transversely to the chain direction for receiving a connecting bolt. There is at least one tension member wrap for transferring tensile forces from one connecting means to the other connecting means.

### CROSS-REFERENCE TO RELATED APPLICATIONS

This application is a national stage of International Application No. PCT/DE2022/100707 (corresponding to International Publication No. WO 2023/046245) filed on Sep. 21, 2022, which in turn claims priority to German Application No. 10 2021 124 576.1 filed on Sep. 22, 2021. The entire contents of both of those applications are incorporated by reference herein.

The disclosure relates to a track chain for tracked vehicles, in particular for military tracked vehicles, having a plurality of chain links which are arranged one behind the other in the chain direction and are pivotably connected to one another, each having two connecting means, wherein at least one connecting means is designed as a tubular bolt receptacle extending transversely to the chain direction for receiving a connecting bolt.

### BACKGROUND

Track chains are usually used to drive land vehicles on unpaved or uneven terrain, as wheels are often unable to provide the necessary traction on such surfaces. Accordingly, track chains are also often used on military vehicles, as these are used on a wide variety of surfaces and reliable maneuverability must be ensured at all times.

Corresponding track chains consist of several chain links arranged one behind the other and pivotably connected to each other, which are connected to each other in the manner of an endless chain. The direction in which the individual chain links are lined up and connected to each other is also referred to as the chain direction. In order to connect the individual chain links together to form an endless chain, the chain links each have two connecting means, which are generally arranged in two opposite end areas of the chain links. The connecting means are each used to connect the chain link to the neighboring chain links, so that a connection to the previous chain link can be made via one of the two connecting means and a connection to the following chain link can be made via the other connecting means.

Often, at least one connecting means of the chain links is designed as a tubular bolt receptacle that extends transversely to the chain direction and serves as a receptacle for a connecting bolt. The chain link can then be pivotally connected to a neighboring chain link via the connecting bolt.

Especially when a track chain is used to drive a military vehicle, which can easily weigh over 20 tons due to the armoring, the chain is not only subjected to high wheel contact forces perpendicular to the ground, but also to very high tensile forces in the direction of the chain. Rubber chain links in particular, which offer some advantages over metal chains due to their lower weight, for example, can be damaged relatively quickly due to the high tensile forces in the chain. This is because the tensile forces can cause cracks and damage, particularly in the area between the connecting links, which can even lead to the chain breaking after a long period of time, making the vehicle practically impossible to maneuver.

### SUMMARY

Based on this, the disclosure sets itself the task of providing a track chain that has a higher resistance.

This problem is solved in a track chain of the type mentioned at the beginning in that at least one tension member wrap is provided for transmitting tensile forces from one connecting means to the other connecting means.

The tension member wrap can significantly increase the tensile strength of the chain links and therefore the track chain as a whole. This is because the tension member wraps mean that the tensile forces no longer have to be transferred from one connecting means to the other through the rubber between the connecting means. Instead, a large proportion of the tensile forces can be transferred via the tension member wraps, which are designed to transfer large tensile forces. The tensile stability of the chain links is thus improved, significantly increasing the chain's resistance.

In a further development, it may be advantageous if the tension member wrap is embedded in a plastic compound together with the two connecting means to form a tubular body. The tubular body can be the actual core piece of the chain link, which also comprises the two connecting means and the tension member wrap. In this respect, the chain link can be a plastic or rubber chain link. These terms are used synonymously below. In particular, it is hard rubber in one case. Tubular bodies or chain links made of rubber have weight advantages over chain links made of metal and, due to their flexibility, they also protect the ground, which is particularly useful when travelling in urban areas or on asphalt. Furthermore, the vibrations and noise emissions of rubber chain links are much lower than those of steel chain links.

To produce the tube body, the two connecting elements can first be placed in a mold together with the tension member wrap and a raw rubber compound. The rubber mass can then be cross-linked, for example by vulcanization, which gives it its stability. It is also possible for the connecting means and the tension member wrap to be molded or insert molded together. The mold can give the tubular body and therefore also the chain link its geometric shape. The rubber material can be used to connect the connecting means and the tension member to each other in a materially bonded and non-detachable manner.

With regard to the tension member wrap, it may be advantageous if this comprises a fabric material, which in particular comprises aramid, nylon, glass, carbon fibers or metal. These materials can absorb very high tensile forces and therefore increase the resistance of the chain links or the chain as a whole. Compressive forces, on the other hand, can be absorbed well by the plastic or rubber mass. The tension member wrap can be designed as a thread, fabric wrap, tape or wire and wound onto the two connecting means.

It also may be advantageous if the elasticity and extensibility of the tubular bodies can be adjusted by the tension member wraps. For example, by selecting certain materials, it is possible to set the tensile stresses that the tubular bodies and therefore also the chain links can withstand. Furthermore, this can also be adjusted by the amount of tension member material used or by the number of wraps or the diameter of the corresponding wrap material.

It also may be advantageous if the connecting means are made of metal, in particular steel. For example, the bolt receptacle can be a steel tube. Metal enables high stability and good transmission of forces through the tension member wraps. The connecting means can extend through the entire tube body so that the tensile forces act as far as possible in the chain direction and can therefore be reliably transferred from one connecting means to the other by the tension member wrap. It can also be provided that the bolt receptacle is rubberized on the inside. This can be particularly advantageous if the connecting bolt is also made of metal, especially steel, so that there is no friction between metal and metal.

With regard to the tubular bodies, it may be advantageous if they have a profiled running surface and a rolling surface opposite the running surface. The profiled running surface can provide more traction on the ground and thus ensure that the vehicle in question can move forward reliably. In this respect, the running surface can be the outer side of the tubular body or the chain links. The rolling surface opposite the running surface, on the other hand, can be flat and smooth, so that the running wheels of the vehicle can roll reliably on this side of the chain links. The profiled running surface can be created during the manufacturing process of the tubular body, so that the injection, vulcanization or casting mold can be designed accordingly. Alternatively, the profiling of the running surface can also be added in a subsequent step.

To ensure stable lateral guidance, it may be advantageous if the chain links of the track chain have at least one guide tooth. The guide tooth can be arranged on the rolling surface of the chain link and thus ensure that the chain cannot jump off the side of the vehicle or the running wheels. The guide tooth then also enables fast cornering with a high centrifugal load. It is possible for the guide tooth to be an integral part of the respective tubular body. The guide tooth can therefore be formed directly during the manufacture of the tubular body, for example by designing the mold accordingly. Furthermore, the guide tooth can also be added or molded onto the tubular body at a later stage. It is also possible for the guide tooth to be detachable from the tubular body. The guide tooth can be arranged in the center or at the side of the chain link and, for example, between two tubular bodies. Several guide teeth can also be provided per chain link.

According to an advantageous development, it is provided that the tension member wrap for transmitting the tensile forces between the two connecting means is guided around the two connecting means in the manner of a circulation strand. Between the two connecting means, the tension member can form an upper strand and a lower strand, which run parallel to each other. The tensile forces to be transmitted can be distributed as evenly as possible between the upper strand and the lower strand. The distance between the upper and lower strands can correspond to the diameter of the connecting means. The tension member wraps can be wound onto the two connecting means. Furthermore, several tension member wraps can also be provided per chain link. For example, it is possible to use either a wider tension member wrap or alternatively several narrower tension member wraps. The narrower tension member wraps can be arranged at a distance from each other and, in particular, be used in the outer areas of the chain link or be guided around the outer areas of the connecting means.

According to an advantageous further development, it is proposed that both connecting means are designed as tubular bolt receptacles. Both bolt receptacles can be aligned transversely to the chain direction and thus run parallel to each other. The bolt receptacles can be arranged in opposite end regions of the tubular body or chain link. The two bolt receptacles ensure that the chain link can be connected to neighboring chain links on both sides via connecting bolts extending through the bolt receptacles.

Furthermore, it may be advantageous with regard to the two bolt receptacles if the tension member wrap is guided around the two bolt receptacles. The tension member wrap can, for example, be wound directly onto the two bolt receptacles. However, in order to ensure reliable force distribution, it may be advantageous if two tension member wraps are provided, which are guided around the two bolt receptacles at a distance from each other. This leads to reliable force transmission.

In order to simplify the positioning of the tension member wraps on the bolt receptacle, these can have projections, in particular ring-shaped projections, for positioning the tension member wrap. The projections can be ring-shaped and thus act as a shoulder that prevents axial movement of the tension member wraps on the bolt receptacles. In this respect, two annular projections can be provided per tension member wrap so that the tension member wrap cannot move axially in any direction on the bolt receptacle. The corresponding projections can be integrally connected to the bolt receptacle or molded onto it. However, it is also possible to slide the projections onto the bolt receptacles in the form of rings. If the tubular body or the chain link has two bolt receptacles and two tension member wraps, each bolt receptacle can be equipped with four projections in order to reliably prevent axial movement of the tension member wraps on both bolt receptacles in both directions.

To further increase stability, it may be advantageous if the tubular bodies have a traverse extending transversely to the chain direction for additional force absorption. The traverse can ensure greater stability of the chain links and, in particular, absorb transverse forces. The traverse can also prevent the tubular bodies from twisting, which could also lead to cracks. The traverse can be made of a fiber composite material or a light metal. The traverse can therefore be comparatively light and only slightly increase the weight of the chain links. Nevertheless, the traverse can also be made of heavier metals, such as steel. In terms of design, the traverse can be in the form of a bar, block or strand. The traverse can also be bolt-shaped or tubular. The traverse can be embedded in the rubber or plastic material together with the connecting means and the tension member means. In this respect, the traverse can also be bonded inseparably to the other elements of the chain link. The traverse can extend between the upper and lower strand of the tension member wraps.

With regard to the arrangement of the traverse, it may be advantageous if it is arranged between the two connecting means or the two bolt receptacles. The traverse can therefore extend parallel to the two connecting means or the bolt receptacles and have the same distance to both connecting means or bolt receptacles. This allows an even distribution of force to be realized, which is as independent as possible of the direction in which the force is applied.

It may be advantageous if the guide tooth is connected to the traverse, particularly before the tubular body is vulcanized. This design means that the guide tooth can also absorb relatively high transverse forces and cannot be sheared off the chain link even under high forces. In this context, the fact that the guide tooth is connected to the traverse does not mean that the guide tooth is only connected via the rubber or plastic material of the chain link, but rather that forces can be transferred directly from the guide tooth to the traverse. In terms of design, the guide tooth can, for example, have a bush-shaped opening through which the traverse can extend. The traverse can therefore already be connected to the guide tooth before the chain link is molded or the traverse and guide tooth can be designed as a preformed element and then embedded together in the rubber or plastic compound.

In a further development, a preformed tension member is proposed, which comprises the tension member wrap. This preformed tension member facilitates the assembly or connection of the tension member wrap to the connecting means. This is because the tension member wrap does not have to be wound onto the connecting means, but the preformed tension member wrap element can be fitted as a whole onto the two connecting means.

In terms of design, the tension member can have two coil bodies around which the tension member wrap is guided. The two coil bodies can be embedded in a plastic compound together with the tension member wrap and thus form the pre-molded tension member. During production of the chain link, this can be pushed onto the two connecting means as a preformed element and then embedded together with them in the rubber or plastic compound. With this design, it is therefore not absolutely necessary to equip the bolt receptacles with projections for positioning the tension member wraps.

The coil bodies of the tension member can be tubular so that the connecting means or the bolt receptacles can be inserted into the spool bodies. The outer diameter of the bolt receptacle can correspond approximately to the inner diameter of the spool bodies so that the tension members do not slip or tilt when they are plugged onto the bolt receptacles. As with the tension member wraps, several tension members can be used per tubular body. These can be slipped onto the two connecting means in the axial direction, depending on the forces to be expected and also depending on how wide the tension members or how wide the connecting means are. In practice, two preformed tension members per tubular body, arranged at a distance from each other, may be advantageous.

Furthermore, it may be advantageous if the tension member has a positioning opening for positioning the traverse. The positioning opening can be arranged in the center between the two coil bodies so that the traverse can be positioned in the center of the tubular body. The opening can be adapted to the shape of the traverse so that the traverse can be inserted axially into the opening, for example, but cannot move in a radial direction and cannot slip during the production of the tubular body. If two tension members are provided, it can be ensured that both the traverse and the connecting means are connected to each other at least two points via the tension member means. This prevents the elements from moving relative to each other when they are embedded in the rubber or plastic mass. To form the tubular body, the two bolt receptacles can be embedded in the rubber or plastic compound together with one or more preformed tension members and also with the traverse, so that the elements are firmly connected to each other after curing or vulcanization.

According to a further advantageous embodiment, it is proposed that at least two tubular bodies are connected to one another via connecting elements, in particular pivotably, to form a connector chain. In this respect, the tubular bodies do not have to be directly connected to each other, but connecting elements can be provided which are each connected to two adjacent tubular bodies and then connect them to each other in a swiveling manner. A connecting element can be connected to two different tubular bodies so that the two tubular bodies are indirectly connected to each other via the connecting element.

To connect a tubular body to a connecting element, it may be advantageous if a connecting bolt is provided which is mounted in one of the bolt receptacles and via which the tubular body can be connected to a connecting element. The connecting bolt can be made of metal, in particular steel, and can also be rubberized, which can reduce friction somewhat. The connecting bolt can protrude laterally from the bolt receptacles so that a connecting element can be connected to one of these protruding areas. A frictional connection can be provided to fasten the connecting element to or on the connecting bolt. For example, the connecting element can be placed on the connecting bolt and then compressed or pulled together in a radial direction in such a way that a frictional connection is formed and the connecting element cannot move axially relative to the connecting bolt. This fixation then also connects the tubular body to the connecting element. It may be advantageous if the connecting bolt is connected to a connecting element in a corresponding manner, so that the tubular body is essentially arranged between the two connecting elements. Alternatively, or additionally, locking bolts, screws or other securing devices can also be provided to prevent the connecting element from moving axially on the connecting bolt.

According to a further advantageous embodiment, it is proposed that the connecting elements are connected to the connecting bolts via connecting bushes. The connecting bushes can be plugged onto the ends of the connecting bolts and can be positively connected to the connecting bolts, for example by means of bolts. The bolts can be inserted through the connecting elements and through the connecting bolt in a radial direction and then lead to a positive locking of the connecting elements on the connecting bolts. The connecting bushes thus ensure reliable axial securing.

It may be advantageous if the connecting elements can be swiveled relative to the tubular bodies about the axes of the connecting bolts. This means that the individual tubular bodies can also be swiveled towards each other and can then be connected together to form a continuous and closed track chain.

It may be advantageous if the tubular bodies are connected to a connecting element on both sides at right angles to the chain direction. The connecting elements can be arranged on the side of the tubular bodies. The connecting elements can protrude in the chain direction opposite a tubular body so that the subsequent tubular body can then also be connected to the two connecting elements of the preceding tubular body. In this respect, the tubular body can also be connected to a connecting element on both sides in the chain direction. Four connecting elements can therefore be assigned to each tubular body.

According to an advantageous further development, it is proposed that two tubular bodies arranged next to each other transversely to the chain direction are connected to each other via at least one connecting bolt to form a double chain link. Such a double chain link can provide a wider running surface and thus reduce the underground load. The bolt receptacles of the two tubular bodies arranged next to each other can be arranged concentrically to each other so that a connecting bolt can be inserted through the bolt receptacles of the two tubular bodies. The chain links are advantageously connected to each other via two connecting bolts. The double chain link, just like the individual chain links, can be connected to neighboring chain links via connecting elements. The connecting bolts can protrude on one side in relation to the tubular body of one chain link and on the other side in relation to the tubular body of the other chain link. In the case of double chain links, the guide tooth can be arranged between the two individual tubular bodies, as this corresponds to the center of the double chain link. The guide tooth can also be attached to the connecting bolts between the two tubular bodies, for example.

In a further development, it is proposed that the height of the connecting element corresponds to the height of the tubular body. This embodiment enables the running wheels to roll not only on the tubular bodies, but also simultaneously on the connecting elements arranged next to the tubular bodies, which increases the effective rolling surface in this respect. At the same time, the running surfaces and thus the traction of the chain can also be increased, as the connecting elements also come into contact with the ground.

In this respect, it may be advantageous if the connecting element has a rolling surface that extends the rolling surface of the chain link. The rolling surface of the connecting element can extend parallel to the rolling surface of the tubular body, so that the running wheel can roll both on the rolling surface of the tubular body and on the rolling surface of the connecting element. As the connecting elements can be pivotably connected to the tubular bodies, the rolling surfaces do not always have to be aligned parallel to each other. The surfaces may not be parallel, particularly in the area of the front and rear deflections of the chain.

With regard to the design of the connecting element, it may be advantageous if it has two connection means, each for connection to a tubular body. One connection means can be designed as a tubular connecting bolt receptacle for receiving a connecting bolt. The connection means can be arranged in two opposite end areas of the connecting element and extend transversely to the chain direction. In this respect, the connecting element can be constructed in the same way as the tubular body, except that it can be narrower and the distance between the connecting means can be smaller than the distance between the connecting means of the tubular body. In terms of their design and function, however, the connecting means of the connecting elements can basically correspond to the connecting means of the tubular bodies. In this respect, the connecting element can correspond to a scaled-down version of the tubular body.

The connecting element can also have a connecting wrap for transferring tensile forces from one connecting means to the other connecting means. The connecting wrap can be designed in the same way as the tension member wrap used in the tubular body. It is also possible for the connecting wraps to be part of a preformed connecting wrap. For the design of the connecting wrap element, please refer to the design of the preformed tension member wrap.

The connecting wrap can be guided around the two connecting means in the manner of a circulation strand to transfer tensile forces between the connecting means. This allows tensile forces to be reliably absorbed between the two connecting means. Between the two connecting means, the connecting wrap can form an upper strand and a lower strand, which can run parallel to each other. The tensile forces to be transmitted can be distributed as evenly as possible between the upper strand and the lower strand. The distance between the upper and lower strands can correspond to the diameter of the connecting means. The connecting wrap can be wound onto the two connecting means.

Furthermore, it may be provided that the connecting wrap is embedded in a plastic compound together with the two connecting means to form a connecting element. The plastic or rubber compound can be the same material that is used for the tubular bodies. The connecting means can be embedded in the rubber or plastic compound together with the connecting wrap(s) and this can then harden, for example by vulcanization, whereby the elements are then bonded to each other. It is also possible to provide several connecting wraps. Similar to the production of the tubular body, injection molding processes can also be used to produce the connecting element.

Furthermore, it may be advantageous if both connecting means are designed as connecting bolt receptacles. The connecting wraps can be wound directly onto the connecting bolt receptacles and, analogous to the design of the bolt receptacles of the chain link, projections, in particular in the form of rings, can be provided to facilitate positioning of the connecting wrap on the connecting bolt receptacles. The connecting means can be tubular so that the connecting bolt can be inserted through the connecting bolt receptacle of the connecting element and through the bolt receptacle of the chain link. In this way, a connecting element can be connected to a tubular body.

Furthermore, it may be advantageous if one of the connecting bolt receptacles is aligned with the bolt receptacle of a chain link and the other connecting bolt receptacle is aligned with the bolt receptacle of another chain link. In this way, the two adjoining tubular bodies can be connected to each other via the connecting element. For this purpose, a connecting bolt can be inserted through a bolt receptacle and through a connecting bolt receptacle of the connecting element and another connecting bolt can be inserted through the other connecting bolt receptacle of the connecting element and through the bolt receptacle of the neighboring tubular body.

According to a further advantageous embodiment, it may be provided that each tubular body is integrally connected to at least one, in particular two, connecting elements to form a hinge chain link. In this respect, the chain link can be vulcanized or injection-molded or cast together with the connecting element, so that the chain link and the connecting element or the connecting elements are then connected to one another in one piece. The connecting elements can be integrally connected to a tubular body on one side and detachably connected to an adjacent tubular body on the other side via a connecting bolt. The connecting bolts can then form the swiveling axes about which the hinge chain links can be swiveled towards each other.

In order to ensure an even distribution of force between the individual chain links, it may be advantageous if the tubular body of each chain link is pivotably connected to a neighboring tubular body via two connecting elements. The forces can thus be evenly distributed between the two connecting elements. Each tubular body can thus be connected in one piece with two connecting elements, so that a hinge chain link can basically consist of one tubular body and two connecting elements. The hinge chain links can have a uniform height so that the connecting elements can also pass over them and thus increase the effective rolling surface.

In order to connect the hinge chain links to each other, it may be advantageous if the connecting bolt receptacles of the connecting elements are arranged concentrically to the bolt receptacle of an adjacent tubular body or chain link.

To connect two hinge chain links, the connecting bolt can extend through the connecting bolt receptacles of the two connecting elements and through the bolt receptacle of the neighboring chain link. At the ends, the connecting bolt can be secured by connecting bushes in such a way that it cannot move in an axial direction relative to the hinge chain link and there is therefore no risk of it slipping out of the connecting bolt receptacles. The securing of the connecting bolt is independent of whether the connecting elements are integrally connected to the chain link or not. In this respect, reference is made to the above.

It may be advantageous if the bolt receptacle of one hinge chain link is arranged between the two connecting bolt receptacles of the neighboring hinge chain link. In this respect, a swiveling connection of the two hinge chain links is then possible via a single straight connecting bolt.

Furthermore, it may be advantageous if a connecting traverse is provided, which is in sections part of the tubular body as connecting means and in sections part of the connecting element as connecting means. In this case, the tubular body and the connecting elements can each have only one bolt receptacle or one connecting bolt receptacle. The connecting traverse can extend through the tubular body into the two connecting elements and thus ensure force transmission between the tubular body and the connecting elements. This allows comparatively large forces to be absorbed by the hinge chain link and the tubular body and the connecting elements are not only connected to each other in one piece by the plastic or rubber compound. The connecting traverse can be embedded in the plastic or rubber compound and thus also be inseparably connected to the other elements of the hinge chain link. The tubular body can also continue to have a traverse, which can then be arranged between the connecting traverse on one side and the bolt receptacle on the other side. The same applies to the connecting element.

Furthermore, it may be advantageous if the connecting wrap of the connecting element is guided around the connecting bolt receptacle and around the connecting traverse and the tension member wrap of the tube body is guided around the bolt receptacle and around the connecting traverse. In this way, tensile forces can be transferred from the bolt receptacle to the connecting traverse and then to the connecting bolt receptacle. As the connecting bolt receptacle of the hinge chain link is connected to the corresponding bolt receptacle of the neighboring hinge chain link via the connecting bolt, tensile forces can be transferred from one hinge chain link to the next hinge chain link.

From a design point of view, it also may be advantageous if the tension members wrap of the tubular body are guided around the connecting traverse between the connecting wraps of the two connecting elements. In this way, an even distribution of force can be ensured so that tensile forces from the tubular body or the chain link can be evenly distributed to the two connecting elements via the tension member wrap(s). In this respect, the tension member wrap(s) can be arranged between the two connecting wraps.

According to an advantageous further development, it is proposed that the tubular body has a traction aid to increase traction. The traction aid can be used to increase the downforce, particularly on soft, snow-covered or icy surfaces. The traction aid can be arranged on the running surface of the tubular body or the chain link so that the traction aid comes into contact with the ground. The traction aid can be made of metal, in particular steel, so that it has a higher strength than the rubber material of the tubular body. Due to the higher strength, the traction aid is subject to less wear. The traction aid can protrude from the surface of the tubular body so that it grips the ground and thus leads to increased traction. The traction aid can be embedded in the rubber material of the tubular body, resulting in a very stable connection with the other components. The traction aid can therefore be an integral part of the tubular body and be inseparably connected to the other components.

With regard to the task mentioned at the beginning, a chain drive for a vehicle, in particular a military vehicle, is also proposed, wherein the chain drive has a track chain which is designed in the manner described above. In addition, the chain drive can have at least one drive pinion and a plurality of running wheels around which the track chain is guided.

It may be advantageous for driving the chain if the drive pinion engages in the spaces between two connecting bushes and thus drives the track chain. A force that drives the track chain can thus be exerted on the connecting bolts via the drive pinion.

Furthermore, with regard to the task mentioned at the beginning, a tracked vehicle, in particular a military tracked vehicle, is proposed which has a track drive designed in the manner described above or a track chain designed in the manner described above. In particular, the vehicle can be armored against ballistic damage. The vehicle can be a land vehicle, such as a transport vehicle, an armored personnel carrier, but also a battle tank or an amphibious vehicle.

### BRIEF DESCRIPTION OF THE DRAWINGS

Further details and advantages will be explained in more detail below with reference to the accompanying schematic drawings. Showing therein:

FIG. 1a is a partially sectioned view of a tubular body in a first embodiment;

FIG. 1b is a different, partially sectioned view of a tubular body in the first embodiment;

FIG. 1c is a different, partially sectioned view of a tubular body in the first embodiment;

FIG. 2a is a different, partially sectioned view of a chain link in a further embodiment;

FIG. 2b is a different, partially sectioned view of a chain link in the further embodiment;

FIG. 3 is a chain link with two connecting elements;

FIG. 4 is a double chain link consisting of two interconnected tubular bodies;

FIG. 5 is a track chain consisting of several interconnected chain links;

FIG. 6 is a view of a chain link of a further embodiment;

FIG. 7 is a view of a connecting element and the individual components of the connecting element;

FIG. 8a is a different view of a running wheel rolling on a track chain;

FIG. 8b is a different view of a running wheel rolling on a track chain;

FIG. 9 is a track chain designed as a connector chain, which is driven by a drive pinion;

FIG. 10a is a different view of a hinge chain link;

FIG. 10b is a different view of a hinge chain link;

FIG. 10c is a different view of a hinge chain link;

FIG. 11 is a hinge chain consisting of several hinge chain links;

FIG. 12a is a tubular body with a traction aid;

FIG. 12b is a track chain with chain links that have a traction aid.

### DETAILED DESCRIPTION

Track chains 10 are used in particular for vehicles that have to move reliably on various uneven or unpaved surfaces. Such track chains 10 consist of several chain links 1 arranged one behind the other and connected to form a circulating track chain 10.

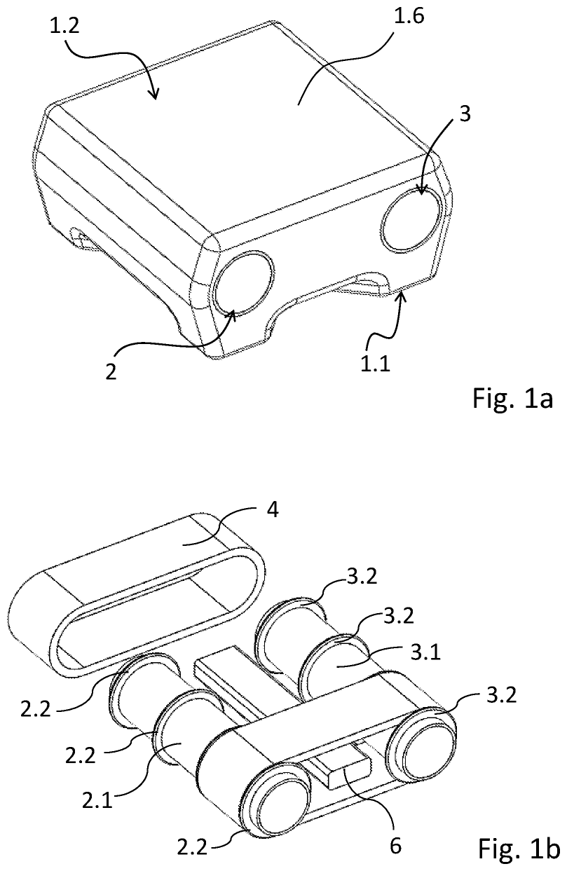

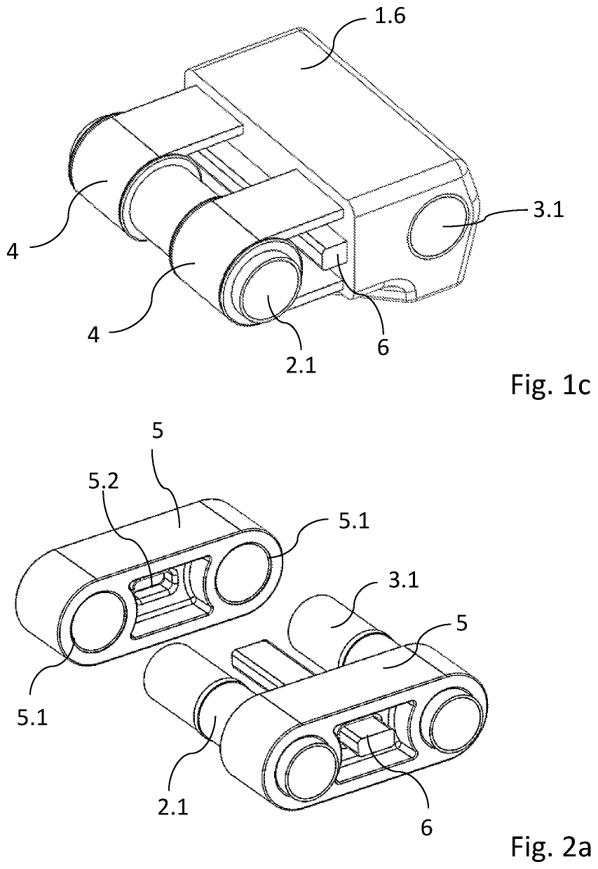

The illustrations in FIGS. 1a to 1c show a tubular body 1.6 of a chain link 1 of such a track chain 10 in perspective views. The internal structure of the tubular body 1.6 can be seen in FIG. 1b. The tubular body 1.6 has two connecting means 2, 3 arranged parallel to each other, which are each designed as tubular bolt receptacles 2.1, 3.1. These can also be seen in FIG. 1a. Connecting bolts 8 can be inserted through the bolt receptacles 2.1, 3.1, which serve to connect the tubular body 1.6 to a tubular body 1.6 of a neighboring chain link 1 in a pivoting manner. Since each tubular body 1.6 has two bolt receptacles 2.1, 3.1, each tubular body 1.6 can therefore also be connected to two further tubular bodies 1.6 of neighboring chain links 1 to form a circumferentially closed track chain 10.

The tubular body 1.6 essentially comprises a rubber material that is capable of absorbing large compressive forces but only limited tensile forces. In order to increase the tensile load capacity in this respect, two tension member wraps 4 are embedded in the tubular body 1.6, which are laid around the two connecting means 2, 3 at a distance from each other in the manner of a circulation strand. The tension member wraps 4 consist of a fiber material that can reliably transfer tensile forces from one connecting means 2 to the other connecting means 3. Compressive forces can hardly be transmitted via the connecting wraps 4, but this is not necessary as they can be transmitted via the rubber mass, especially as the track chain 10 is primarily subjected to tensile stress anyway, at least in the chain direction K. The chain direction K is the direction in which the individual tubular bodies 1.6 or chain links 1 are connected to each other, as can also be seen in FIG. 3 or FIG. 5, for example.

In order to fasten the tension member wraps 4 on the connecting means 2, 3 or on the bolt receptacles 2.1, 3.1, these have projections 2.2, 3.2 which prevent the tension member wraps 4 from moving in an axial direction on the bolt receptacles 2.1, 3.1. The corresponding projections 2.2, 3.2 thus serve as positioning aids in the manner of shoulders and ensure that the tension member wraps 4 do not slip even during molding or embedding in the rubber compound.

As can also be seen in FIG. 1b, the tubular body 1.6 of the chain link 1 has a bar-shaped traverse 6, which is arranged parallel to the connecting means 2, 3 in the center of the tubular body 1.6 transversely to the chain direction K. This traverse 6 consists of a light metal or a fiber composite. This traverse 6 is made of a light metal or a fiber composite material and serves to stabilize and absorb transverse and torsional forces.

The elements to be recognized in FIG. 1b basically represent the interior design of the tubular body 1.6 or chain link 1. In FIG. 1c, the tubular body 1.6 is shown in a sectional view, so that the inner elements embedded in the rubber compound can be seen in the left part of FIG. 1c and the outer structure of the tubular body 1.6 can be seen on the right. During production, the inner elements are positioned in a mold as shown in FIG. 1b and enclosed by a raw rubber material. After vulcanization of the rubber material, the individual polymer chains have cross-linked with each other and the elements are inseparably enclosed in the tubular body 1.6. The final tubular body 1.6 can be seen in FIG. 1a.

As can also be seen from FIG. 1a, the tubular body 1.6 has two different surfaces, namely a profiled running surface 1.1 and a flat rolling surface 1.2 opposite the profiled running surface 1.1. The running surface 1.1 is profiled so that it ensures the best possible traction and maneuverability, even on uneven and unpaved surfaces. This is because the running surface 1.1 is the outer surface of the track chain 10 that comes into contact with the ground. The opposite rolling surface 1.2, on the other hand, is smooth so that the running wheels 11.1 can run smoothly on it. This will be explained in more detail below with reference to the further illustrations of the track 10.

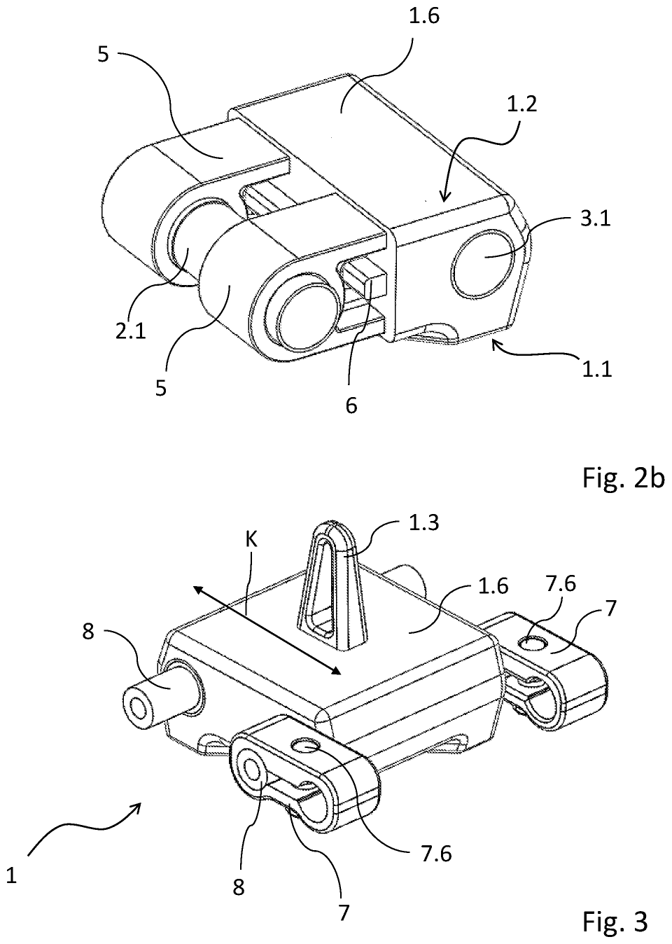

The illustration in FIG. 2 also shows a tubular body 1.6, which has a very similar design to the tubular body 1.6 shown in FIGS. 1a to 1c. The only difference is basically that the tension member wraps 4 are embedded in a preformed tension member 5 in this embodiment. This preformed tension member 5 consists of two coil bodies 5.1, the actual tension member wrap 4 located inside the tension member 5, which is not shown here, and a vulcanized rubber compound, which connects the coil bodies 5.1 to the tension member wrap 4 with a material bond. In order to be able to attach the tension member 5 to the connecting means 2, 3 or the bolt receptacles 2.1, 3.1, the coil bodies 5.1 have an inside diameter that is slightly larger than the outside diameter of the bolt receptacles 2.1, 3.1.

As one can imagine, when the inner components of the chain link 1 as shown in FIG. 1b are embedded in the plastic mass, the individual elements may move relative to each other. As the tension member wraps 4 can basically hardly absorb any compressive forces, the corresponding assembly on the connecting means 2, 3 can be somewhat wobbly unless they are fixed in some other way. The pre-molded tension members 5, on the other hand, can give the two connecting means 2, 3 more stability, so that once the tension members 5 have been pushed onto the connecting means 2, 3, they can no longer easily move relative to each other and can therefore also be reliably embedded in the rubber compound.

As can also be seen in FIG. 2a, the tension members 5 have a positioning opening 5.2, which is adapted to the contour or geometry of the traverse 6. The two tension members 5 can be attached to the two connecting means 2, 3 and to the traverse 6 and thus form a comparatively stable unit, which can then be embedded in the rubber compound in the next step.

In FIG. 2b, the corresponding tubular body 1.6 is shown analogously to the illustration in FIG. 1c, whereby the finished vulcanized tubular body 1.6 can be seen on the right and the inner components and in particular the two preformed tension members 5 on the left in FIG. 2b. When comparing FIGS. 2b and 1 c, it is noticeable that the tension members 5 are thicker than the tension member wraps 4, as these are already embedded in a rubber compound. It can also be seen that the bolt receptacles 2.1, 3.1 in FIG. 1b can be moved towards each other, which is not possible with the preformed tension member 5 due to the coil bodies 5.1.

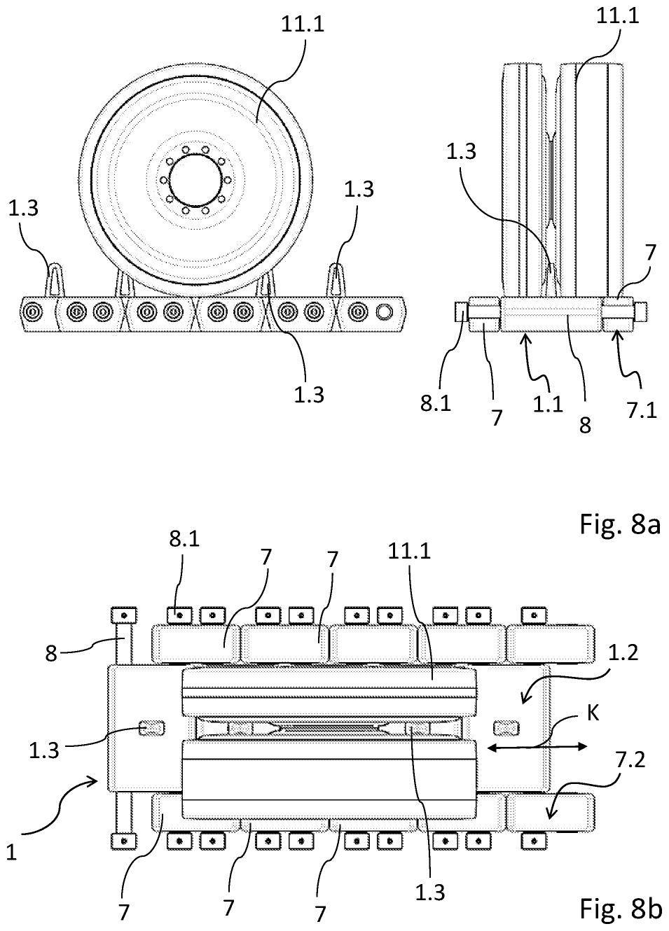

FIG. 3 shows a chain link 1 with a tubular body 1.6 as shown in FIGS. 1a to 1c or also with a tubular body 1.6 as shown in FIGS. 2a to 2b. The chain link 1 has a guide tooth 1.3 protruding vertically from the rolling surface 1.2, which leads to a certain lateral guidance of the track 10. The guide tooth prevents the track chain 10 from jumping off the vehicle. This is also explained in more detail below with reference to FIGS. 8a and 8b.

Furthermore, it can also be seen in FIG. 3 that the bolt receptacles 2.1, 3.1 are each fitted with a connecting bolt 8, which protrudes on both sides opposite the tubular body 1.6. Connecting elements 7 can be attached to each of these protruding sections of the connecting bolt 8, which can then be connected on one side to the connecting bolt 8 extending through a tubular body 1.6 and on the other side to a connecting bolt 8 extending through an adjacent tubular body 1.6 of another chain link 1. In this respect, the connecting elements 7 can be used to connect two tubular bodies 1.6 to each other in a swiveling manner. The tubular body 1.6 then forms the chain link 1 together with the connecting elements 7 and the connecting bolts 8.

As can also be seen in FIG. 3, the connecting elements 7 shown have a recess with a screw thread extending perpendicular to the rolling surface. The connecting elements 7 can be pressed onto the end areas of the connecting bolts 8 by means of screw-in connecting screws 7.6, so that a frictional connection is created between the connecting bolts 8 and the connecting elements 7. Furthermore, additional elements, such as locking bolts, can also be provided to secure the connecting elements 7, which can additionally prevent axial movement of the connecting elements 7 on the connecting bolts 8.

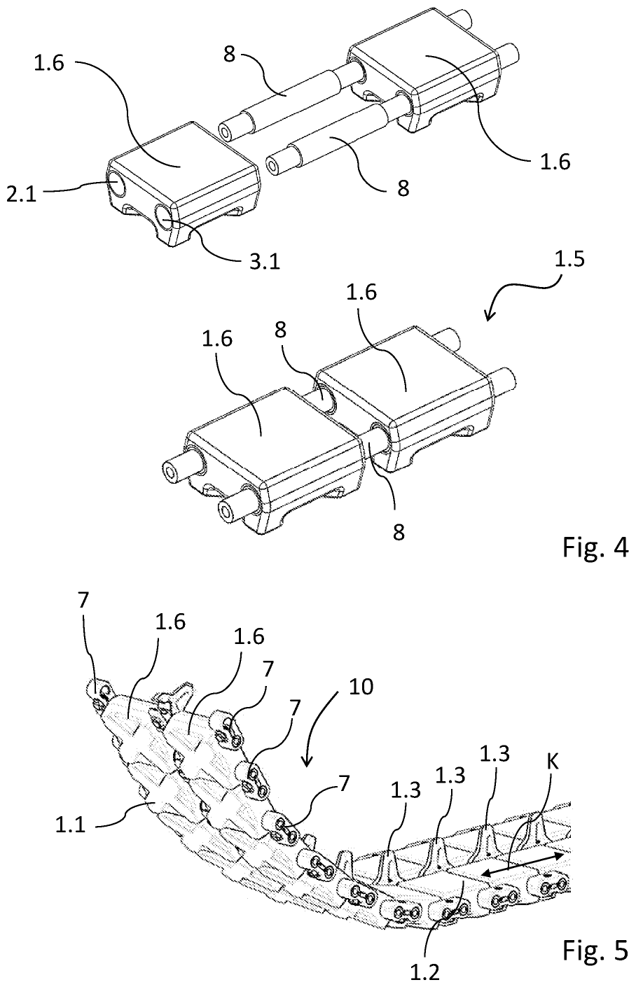

The illustration in FIG. 4 shows a double chain link 1.5, consisting of two tubular bodies 1.6 arranged next to each other, which are connected to each other via two connecting bolts 8. As can be seen, the connecting bolts 8 extend not only through one tubular body 1.6, but through the two tubular bodies 1.6 arranged next to each other. The connecting bolts 8 can be rubberized in the area in which they are arranged within the bolt receptacles 2.1, 3.1. On the one hand, this prevents abrasive metal-on-metal friction and, on the other hand, it can also prevent or impede the tubular bodies 1.6 and the connecting bolts 8 from moving relative to each other in the axial direction.

The tubular bodies 1.6 are the tubular bodies 1.6 that have already been described above with regard to FIGS. 1a to 1c and FIGS. 2a to 2b. The double chain links 1.5 allow the corresponding track chain 10 to be significantly wider overall, so that the edge contact forces are also distributed over a larger area. The double chain links 1.5 are strung together and connected in the same way as has already been described with regard to the individual chain links 1 and will be further described below.

The illustration in FIG. 5 shows a track chain 10 consisting of several double chain links 1.5 arranged one behind the other and pivotably connected to each other. The profiles of the chain links 1, which result in high traction, are clearly recognizable. The connection of the double chain links 1.5 corresponds to that already explained with regard to the single chain link 1 with reference to FIG. 3.

In contrast to the individual chain links 1, where the guide teeth 1.3 are arranged in the center of each chain link 1, the double chain links 1.5 have the guide teeth 1.3 arranged between the two individual tubular bodies 1.6. The guide teeth 1.3 are designed as independent elements and are not firmly connected to the chain links 1, but are also arranged on the connecting bolts 8, just like the tubular bodies 1.6.

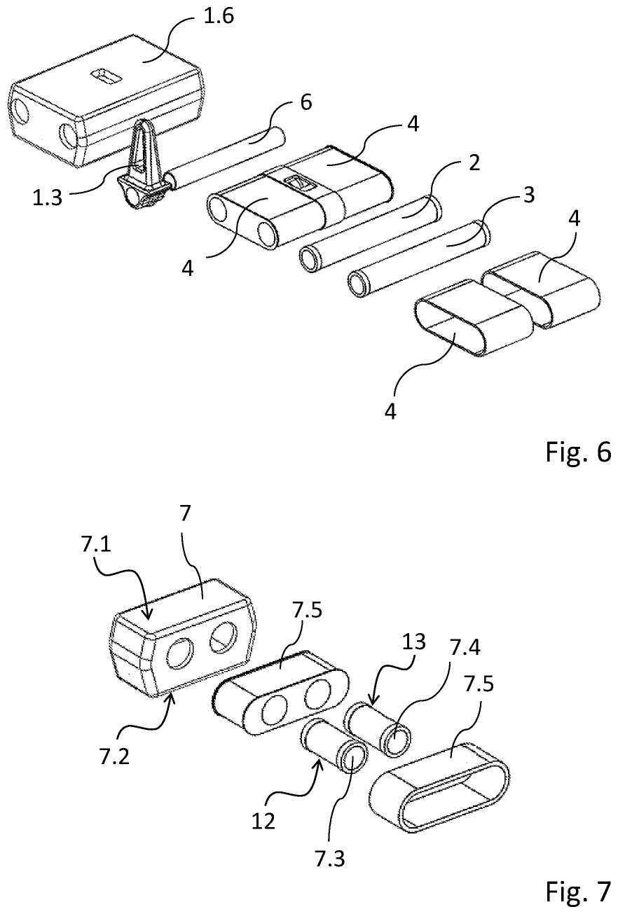

In the illustration in FIG. 6, a tubular body 1.6 is shown in a further embodiment, which has many similarities with the tubular bodies 1.6 described above. What is noticeable when comparing FIG. 1a with FIG. 6, however, is that the tubular body 1 shown in FIG. 6 is significantly wider. Furthermore, the guide tooth 1.3 is connected to the bolt-shaped traverse 6 of this tubular body 1.6. The background to this is that higher forces can be absorbed by the guide tooth 1.3 and it cannot be sheared off so easily from the actual tubular body 1.6, as this is anchored inside the tubular body 1.6 via the traverse 6.

FIG. 6 basically shows the individual manufacturing steps for producing the tubular body 1.6. The two tension member wraps 4 are shown on the right, which are placed around the connecting means 2, 3 designed as bolt receptacles 2.1, 3.1. This can be seen in the center of FIG. 6. In addition, the tension member warps 4 are also closed at the sides by cover plates and a further element is shown in the center between the two tension member wraps 4, which also acts as a kind of support for the guide tooth 1.3. Analogous to the tubular bodies 1.6 already described, the elements of this tubular body 1.6 are also arranged together in a rubber compound, which is then vulcanized in the next step so that the elements are inseparably connected to each other and embedded in the rubber compound. Although the guide tooth 1.3 is shown on the left in FIG. 6 separately from the legal tubular body 1.6, this is also arranged together with the traverse 6 before vulcanization so that it is firmly anchored in the finished tubular body 1.6.

The illustration in FIG. 7 shows a connecting element 7 as used in the track chain 10 shown in FIGS. 8a, 8b below. In the same way as the tubular body 1.6, the connecting element 7 consists of two connecting means 12, 13, which in the illustration in FIG. 7 are each designed as tubular connecting bolt receptacles 7.3, 7.4. A connecting wrap 7.5 is guided around these connecting bolt receptacles 7.3, 7.4 in the manner of a circulation strand, which basically functions in the same way as already described above with regard to the tension member wraps 4 of the tubular body 1.6.

After the connecting wrap 7.5 has been placed around the two connecting bolt receptacles 7.3, 7.4, it is embedded together with the other elements in a rubber or plastic compound, so that the connecting element 7 is then formed. The main difference between the connecting element 7 and the tubular body 1.6 is therefore that the connecting element 7 is narrower, has only one connecting wrap 7.5 and the connecting means 12, 13 are closer together.

An advantage of this connecting element 7 compared to the connecting element 7 shown in FIG. 3, in addition to the reliable absorption of tensile forces by the connecting coil, is that the connecting means can have the same height as the tubular bodies 1.6. This can also be seen in particular in FIGS. 8a, 8b.

FIG. 8a shows a track in a front view and in a side view. As can be seen, the connecting elements 7 arranged next to the tubular bodies 1.6 have the same height as the tubular bodies 1.6, which increases the effective rolling surface 1.2 and the effective running surface 1.1 of the individual chain links 1.

In this respect, the connecting elements 7 can have a running surface 7.1 and a rolling surface 7.2 opposite the running surface, just like the tubular bodies 1.6. The running surface 7.1 can also be profiled, although this cannot be seen in FIGS. 8a and 8b.

The connecting elements 7 are basically connected to the chain links 1 in a very similar way, as already described with regard to FIG. 3. The connecting bolts 8 are pushed through the bolt receptacles 2.1, 3.1 of the tubular bodies 1.6 and protrude laterally beyond the tubular bodies 1.6. The connecting elements 7 with their connecting bolt receptacles 7.3, 7.4 are then pushed onto these laterally protruding sections of the connecting bolts 8, so that each connecting element 7 is connected to two adjacent tubular bodies 1.6 via two connecting bolts 8.

In order to secure the connecting elements 7 in the axial direction on the connecting bolts 8, connecting bushes 8.1 are provided, which can be seen in FIG. 8b, for example. These connecting bushes 8.1 are positively connected to the connecting bolts 8 via a connecting bolt that can be inserted through the connecting bush 8.1 and the connecting bolt 8, so that these secure the connecting elements 7 in the axial direction on the connecting bolts 8. The connecting bolts 8 can thus be used to realize a pivotable connection between the tubular bodies 1.6 and the connecting elements 7 and thus also between the individual chain links 1.

As can also be seen from FIGS. 8a and 8b, the running wheel 11.1 is designed as a double track roller and basically consists of two individual partial running wheels, which are spaced a certain distance apart. The guide tooth 1.3 can engage in the space between the individual partial wheels so that this ensures good lateral guidance of the track chain 10 and the running wheel 11.1 cannot jump off the track chain 10 even when travelling faster around corners. This can be seen, for example, in FIG. 8b and in the right-hand illustration in FIG. 8a. It can also be seen that the outer partial roller is wider than the inner partial roller. This is due to the fact that the connecting elements 7 provide an additional rolling surface 7.2 for the running wheels 11.1 and therefore the running wheel 11.1 can be wider overall than is the case, for example, with the connecting elements 7 shown in FIG. 3.

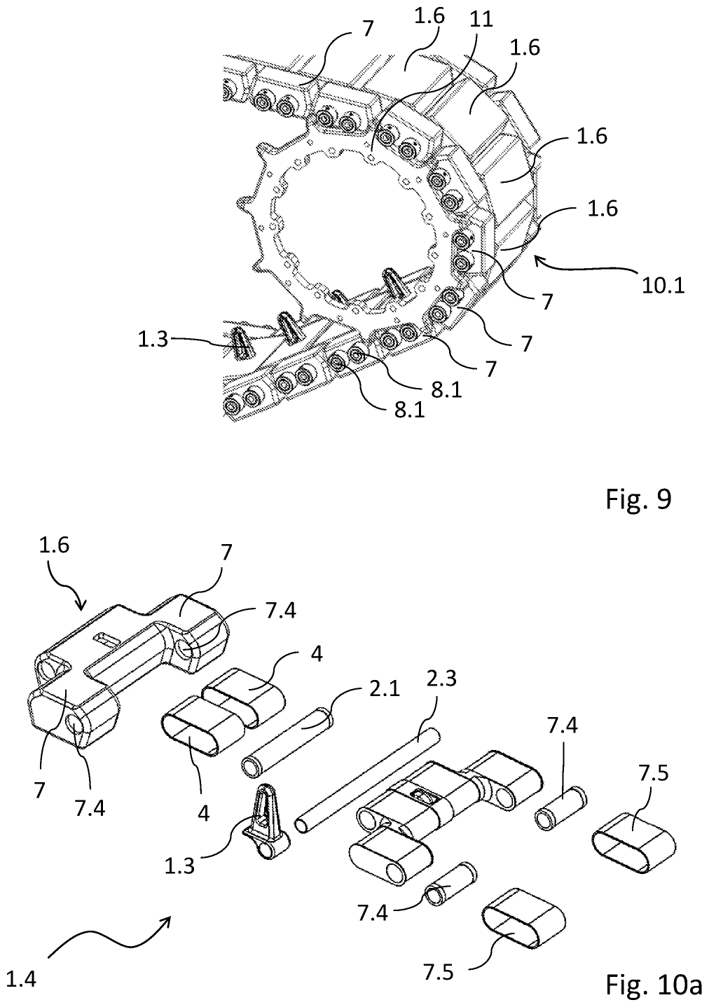

The illustration in FIG. 9 shows the drive of the track 10. The track chain 10 is guided around a drive pinion 11, which engages in the spaces between the connecting bushes 8.1. When the drive pinion is rotated, a force is exerted on the track chain 10, which drives it. Since the individual tubular bodies 1.6 are not connected directly to each other, but rather via connecting elements 7 that are pivotably connected to the tubular bodies 1.6, this type of chain is also referred to as a connector chain 10.1.

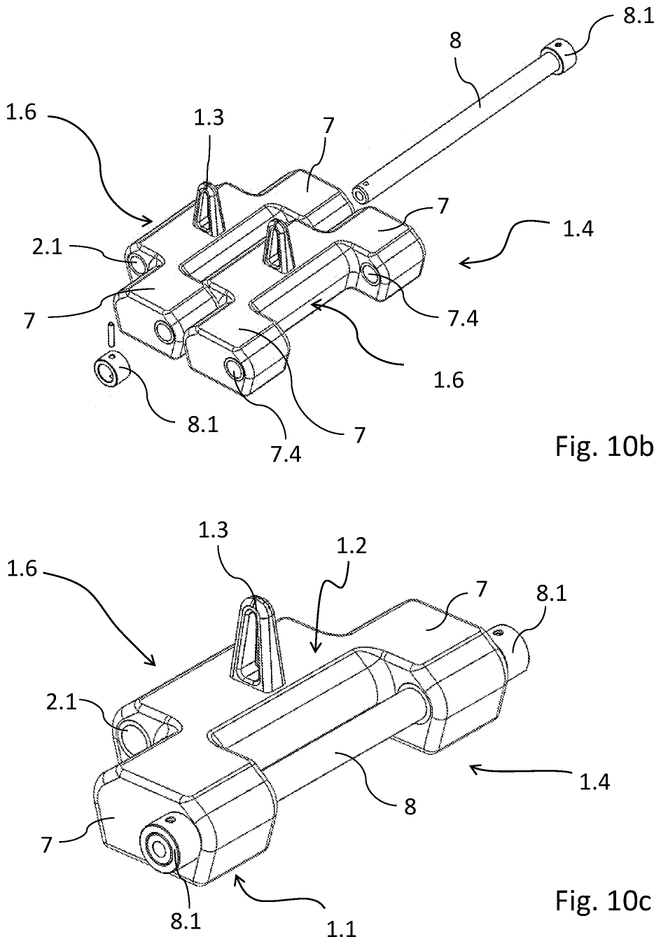

FIGS. 10a to 10c now show a further embodiment. In this case, the tubular bodies 1.6 are not detachably connected to all connecting elements 7 via connecting bolts 8, but each tubular body 1.6 is connected in one piece to two connecting elements 7. The corresponding chain links 1 are then also referred to as hinge chain links 1.4.

The structure of such a hinge chain link 1.4 can be seen in FIG. 10a. The tubular body 1.6 arranged in the center and the connecting elements 7 arranged on the sides of the chain link 1 are basically designed in exactly the same way as described above. The main difference, however, is that the tubular body 1.6 only has a bolt receptacle 2.1 on one side and a connecting traverse 2.3 on the other side of the tubular body 1.6. The same applies to the connecting elements 7, which only have a connecting bolt receptacle 7.4 at one end and the connecting traverse 2.3 on the other opposite side. The connecting traverse 2.3 is thus in sections part of the tubular body 1.6 and in sections part of the connecting elements 7. The connecting traverse 2.3 thus connects the tubular body 1.6 with the two connecting elements 7 to form the chain link 1, so that the connecting elements 7 cannot move relative to the tubular body 1.6.

As already described above, the tubular body 1.6 has two tension member wraps 4, which are then guided around the bolt receptacle 2.1 on one side and around the connecting traverse 2.3 on the other side in the manner of a circulation strand. The connecting wraps 7.5 are arranged in the outer end areas of the connecting traverse 2.3 and these are guided around the connecting traverse 2.3 on one side and around the connecting bolt receptacle 7.4 of the connecting elements 7 on the other side. In the event of a tensile load, the corresponding tensile force is initially transmitted from the bolt receptacle 2.1 to the connecting traverse 2.3 via the tension member wraps 4. This force is then transferred via the connecting traverse 2.3 to the connecting bolt receptacle 7.4 via the connecting wraps 7.5 and from there to the next chain link 1 or the next tubular body 1.6.

When manufacturing the hinge chain link 1.4, the individual elements are initially arranged together again in a vulcanization mold in a rubber compound, as already explained above with regard to the individual tubular bodies 1.6 and also the connecting elements 7. In contrast to the production described above, however, the tubular bodies 1.7 and the connecting elements 7 are now produced in a single step so that they can then be joined together in one piece, as can be seen from the vulcanized hinge chain link 1.4 on the left in FIG. 10a. The guide tooth 1.3 is not shown, but this can also be embedded in the rubber compound together with the other elements, as already explained in FIG. 6. As the connecting traverse 2.3 gives the hinge chain link 1.4 a high degree of stability, the corresponding tubular body 1.6 and the connecting element 7 no longer have an additional traverse 6. The guide tooth 1.3 is then connected to the connecting traverse 2.3 accordingly.

FIG. 10b shows the connection of the hinge chain links 1.4 to form an encircling hinge chain 10.2. The connection of the hinge chain links 1.4 basically functions in a very similar way to that already described above with regard to FIGS. 7 to 9. However, only half the number of connecting bolts 8 is required for the hinge chain 10.2 compared to the connector chain 10.1 in FIG. 9. This is because every second connecting bolt 8 is basically replaced by an embedded connecting traverse 2.3.

In order to connect two hinge chain links 1.4 to each other, the connecting bolt 8 is inserted through the two concentrically arranged connecting bolt receptacles 7.4 of the connecting elements 7 that are integrally connected to the tubular body 1.6. The tubular body 1.6 of the subsequent hinge chain link 1.4 is arranged between the two connecting elements 7 in such a way that the bolt receptacle 2.1 of the subsequent tubular body 1.6 is aligned with the connecting bolt receptacles 7.4 of the connecting elements 7 of the preceding tubular body 1.6. The connecting bolt 8 can therefore be inserted through the two connecting elements 7 and through the chain link 1 of the neighboring hinge chain link 1.4 and thus connect the two hinge chain links 1.4 to each other in a pivoting manner. At each end, the connecting bolt 8 is provided with a connecting bush 8.1, which prevents axial movement of the bolt relative to the hinge chain link 1.4, as already described above.

FIG. 10c shows a hinge chain link 1.4 with an inserted connecting bolt 8. The central area of the connecting bolt 8, which is arranged between the two connecting elements 7, is arranged in the tubular body 1.6 of the neighboring hinge chain link 1.4 in a fully assembled hinge chain 10.2, as can also be seen in FIG. 10b.

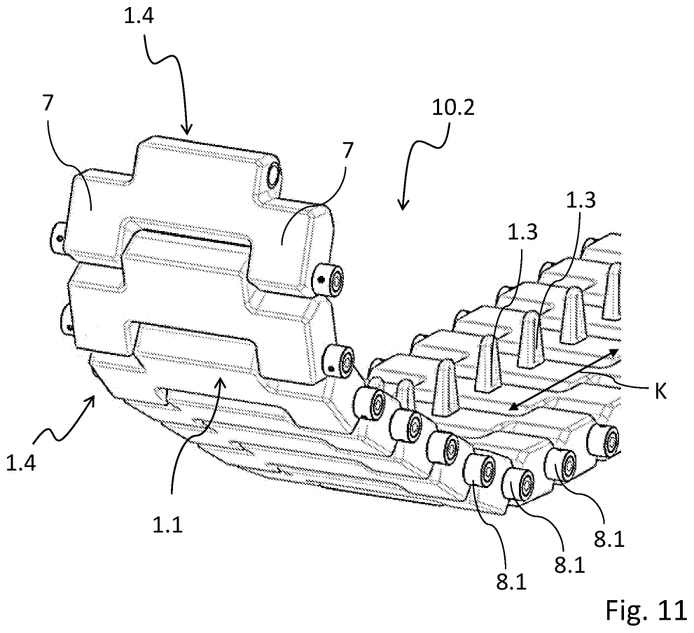

FIG. 11 now shows a fully assembled hinge chain 10.2. This chain can also be driven via the connecting bushes 8.1, for which the drive pinion 11 shown in FIG. 9 can be used, especially as this also only engages on every second connecting bush 8.1 in FIG. 9. Since only half as many connecting bolts 8 and therefore only half as many connecting bushes 8.1 are provided in the hinge chain 10.2 shown in FIG. 11, the drive pinion 11 would then exert a force driving the hinge chain 10.2 on each connecting bush 8.1 in this hinge chain 10.2.

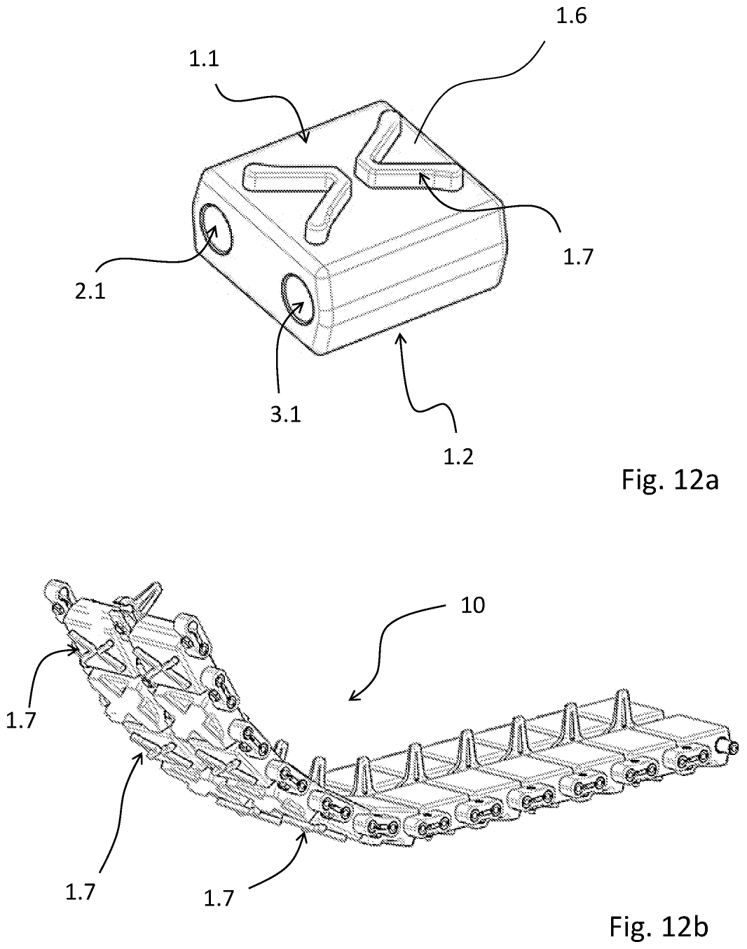

In the illustration of FIG. 12a, a tubular body 1.6 of a chain link 1 is shown from below, so that the running surface 1.1 in contact with the ground can be recognized. The tubular body 1.6 has a traction aid 1.7 on this side, which protrudes above the running surface 1.1 and thus engages in the ground, particularly when travelling on soft or snowy ground, thereby improving traction. To ensure reliable stability of the chain link 1 or the traction aid 1.7, it is made of metal and is vulcanized into the rubber material of the tubular body 1.6.

In terms of design, the traction aid 1.7 consists of two V-shaped metal parts arranged at a distance from each other, the tips of which face each other, as can also be seen in the illustration in FIG. 12a, for example. This geometric shape has proven itself in practice and ensures a significant improvement in traction. Nevertheless, the traction aid 1.7 could also be designed differently in geometric terms, e.g. in the form of one or more discs extending parallel to the bolt receptacles 2.1, 3.1.

FIG. 12b shows a track chain 10 whose chain links 1 or tubular body 1.6 are equipped with corresponding traction aids 1.7. As can be seen from a comparison with FIG. 5, however, only the chain links 1 of every second row are equipped with corresponding traction aids 1.7. The tubular bodies 1.6 of the hinge chain 1.4 can also be equipped with corresponding traction aids 1.7.

### REFERENCE SIGNS

1 Chain link
1.1 Running surface
1.2 Rolling surface
1.3 Guide tooth
1.4 Hinge chain link
1.5 Double chain link
1.6 Tubular body
1.7 Traction aid
2 Connecting means
2.1 Bolt receptacle
2.2 Projections
2.3 Connecting traverse
3 Connecting means
3.1 Bolt receptacle
3.2 Projections
4 Tension member wrap
5 Tension member
5.1 Coil body
5.2 Positioning opening
6 Traverse
7 Connecting element
7.1 Running surface
7.2 Rolling surface
7.3 Connecting bolt receptacle
7.4 Connecting bolt receptacle
7.5 Connecting wrap
7.6 Connecting screw
8 Connecting bolt
8.1 Connecting bush
10 Track chain
10.1 Connector chain
10.2 Hinge chain
11 Drive pinion
11.1 Running wheel
12 Connecting means
13 Connecting means
K Chain direction

What is claimed is:

1. A track chain for tracked vehicles, having a plurality of chain links which are arranged one behind the other in the chain direction and are pivotably connected to one another, each having two connecting means, wherein at least one connecting means is designed as a tubular bolt receptacle extending transversely to the chain direction for receiving a connecting bolt,
wherein the track chain includes
at least one tension member wrap for transferring tensile forces from one connecting means to the other connecting means .

2. A track chain according to claim 1, wherein the tension member wrap is embedded in a plastic compound together with the two connecting means to form a tubular body.

3. A track chain according to claim 2, wherein the elasticity and extensibility of the tubular body is adjustable by the tension member wraps.

4. A track chain according to claim 1, wherein the tension member wrap for transmitting the tensile forces between the connecting means is guided around the two connecting means in the manner of a circulation strand.

5. A track chain according to claim 1, wherein both connecting means are designed as tubular bolt receptacles.

6. A track chain as claimed in claim 5, wherein the bolt receptacles have annular projections for positioning the tension member wrap.

7. A track chain according to claim 1, further including a preformed tension member comprising the tension member wrap.

8. A track chain according to claim 2, wherein at least two tubular bodies are connected to one another via connecting elements to form a connector chain.

9. A track chain according to claim 1, further including two tubular bodies arranged next to each other transversely to the direction of the chain, which are connected to each other via at least one connecting bolt to form a double chain link.

10. A track chain according to claim 8, wherein the height of the connecting element corresponds to the height of the tubular body.

11. A track chain according to claim 8, wherein the connecting element has a rolling surface extending the rolling surface of the chain link.

12. A track chain according to claim 8, wherein the connecting element has two connecting means each for connection to a tubular body, at least one connecting means being designed as a tubular connecting bolt receptacle for receiving a connecting bolt.

13. A track chain according to claim 8, wherein the connecting element has a connecting wrap for transmitting tensile forces from one connecting means to the other connecting means.

14. A track chain according to claim 13, wherein the connecting wrap for transmitting tensile forces between the connecting means is guided around the two connecting means in the manner of a circulation strand.

15. A track chain according to claim 12, wherein each tubular body is connected in one piece to at least one connecting bolt to form a hinge chain link.

16. A track chain according to claim 15, further including a connecting traverse, which is in sections part of the tubular body as connecting means and in sections part of the connecting element as connecting means.

17. A track chain according to claim 16, wherein the connecting wrap of the connecting element is guided around the connecting bolt receptacle and around the connecting traverse and the tension member wrap of the tubular body is guided around the bolt receptacle and around the connecting traverse.

18. A track chain according to claim 2, wherein the tubular body has a traction aid to increase the traction.

19. A track drive for a tracked vehicle with a track chain according to claim 1, which is guided around at least one drive pinion and several running wheels.

20. A tracked vehicle with a track drive according to claim 19.
